(19) United States
(12) Patent Application Publication
(10) Pub. No.: US 2015/0183378 A1
(43) Pub. Date: Jul. 2, 2015

(54) VEHICLE BAG

(71) Applicant: Travis Trenton Tipler, Wainwright (CA)

(72) Inventor: Travis Trenton Tipler, Wainwright (CA)

(21) Appl. No.: 14/142,236

(22) Filed: Dec. 27, 2013

(51) Int. Cl. B60R 7/04

(52) U.S. Cl. CPC B60R 7/043

(57) ABSTRACT

Backseat security bag for securely accommodating lose items inside a vehicle such that under any sudden impact like during an accident or a sudden brake, the items do not momentarily fly around thereby hurting the passengers in the vehicle. The bag comprises a container of a flexible material with an opening that is provided with a releasably locking means. Buckles on the exterior surface of the container are provided for securing the bag to the seat belt of the backseat of a vehicle.

### BACKGROUND OF THE INVENTION

1. Field of Invention

The present application relates to safety measures within vehicles in general and in particular to a method and an apparatus for securing articles within a vehicle.

2. Description of Related Art

Accommodating lose items within the interior of vehicles while driving is common. The lose items may be such as clothing, toys, water bottles, food careers, suitcases and the like. Particularly during long journeys, covered luggage storage spaces may not be adequate to accommodate all the items that need to be taken along. Additionally, in many situations, it may be desirable to keep certain items within the interior of the vehicle, such as on the vehicle floor or on the vacant seats for convenience of easy access while driving.

One difficulty of keeping items within an interior of a vehicle is that during an accident or a sudden brake, under the impact the items within the vehicle easily fly around momentarily, thereby injuring the passengers. Generally speaking, softer items like clothing may seem to be safer than harder objects like toys, suitcases, water bottles and the like. However sometimes during an accident, even the buttons in the clothing may cause substantial damage to the passengers. Additionally, during such accidents, it will also be undesirable for the softer articles to become scattered or distributed around the vehicle or outside of the vehicle.

### SUMMARY OF THE INVENTION

The proposed backseat security bag for securely accommodating lose items inside a vehicle, comprises a container of flexible material with an opening, a releasably locking means for said opening and a buckle on the exterior surface of said container for securing the bag to a coupler of the backseat of vehicle.

The proposed backseat security bag is useful in containing the lose items inside such that under any sudden impact like during an accident or a sudden brake, the items do not momentarily fly around thereby hurting the passengers in the vehicle. The lose items contained inside the bag gives easy access to the passengers while the vehicle is on move rather than when the lose items are stored in exterior compartments.

According to one embodiment, the releasable locking means is a zipper. Zipper ensures complete closure of the opening and is easy to operate as well. Complete closure is desirable for safety as then even during an impact nothing would get thrown out of the container.

According to another embodiment, the bag comprises a plurality of the buckles for securing the bag to the seat belts. This would help in keeping the bag substantially in place even during a strong impact.

According to another embodiment, the bag comprises a plurality of the openings with corresponding releasable locking means. This would enable easier access to the items inside, particularly when they are in big numbers.

According to another embodiment, the bottom surface of the bag is relatively non-deformable and is provided with wheels for transportation. When outside the vehicle, this feature would help in wheeling the bag instead of having to carry.

According to another embodiment, the bag further comprises user carrying straps for carrying the bag on the back when not within vehicle.

According to another embodiment, the bag is extendable to increase the internal volume as required.

According to another embodiment, the bag further comprises at least one strap on the exterior of the container for tightening an extra space left after accommodating items inside.

According to another embodiment, the bag further comprises a plurality of compartments, within the container. This helps in assorted distribution of the items inside for easier access.

According to another embodiment, the bag has a length to stretch over at least two-thirds of the backseat of vehicle.

According to another embodiment, the coupler may comprise a seat belt.

More details about these features will become apparent to those skilled in the art in the following detailed description of the illustrative embodiments exemplifying the best mode for carrying out the disclosure as presently perceived.

The present invention consists of certain novel features and a combination of parts hereinafter fully described and illustrated in the accompanying drawing, it being understood that various changes in the details may be possible without departing from the scope of the invention or sacrificing any of the advantages of the present invention.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a front view of an apparatus for securing articles within a vehicle according to a first embodiment of the present invention.

FIG. 2 is a front view of an apparatus for securing articles within a vehicle according to a further embodiment of the present invention.

FIG. 3 is a front view of an apparatus for securing articles within a vehicle according to a further embodiment of the present invention.

FIG. 4 is a bottom view of the apparatus of FIG. 1 having optional wheels.

FIG. 5 is a cross sectional view of the apparatus of FIG. 1 having a plurality of compartments.

### DETAILED DESCRIPTION

The following description presents several embodiments of the present invention in sufficient detail such that those skilled in the art can make and use the invention.

Before describing in detail embodiments that are in accordance with the present invention, it should be noted that all of the figures are drawn for ease of explanation of the basic teachings of the present invention only. The extension of the figures with respect to the number, position, relationship and dimension of the parts of the embodiments will be within the skill of the art after the following teachings of the present invention have been read and understood. Further, the exact dimensions and dimensional proportions to conform to specific force, weight, strength and similar requirements will likewise be within the skill of the art after the following teachings of the present invention have been read and understood.

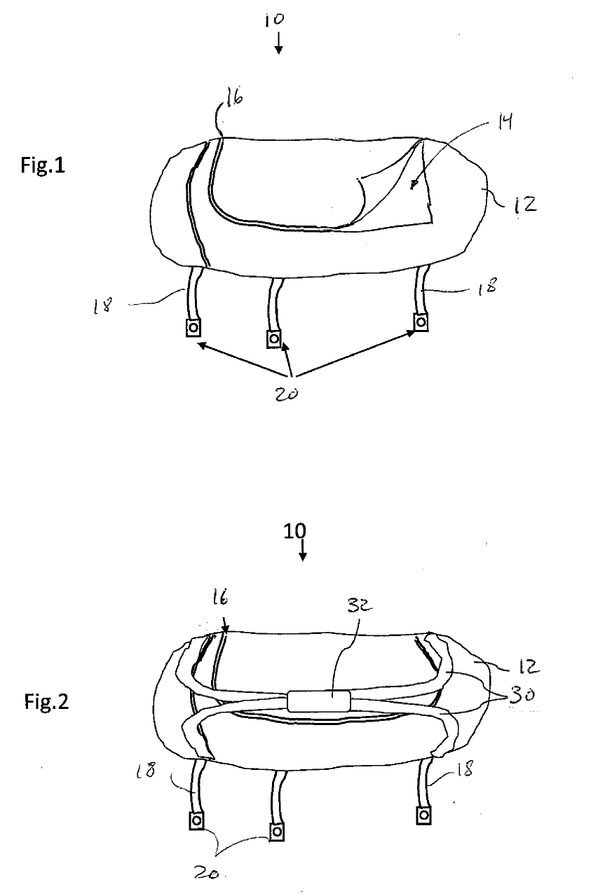

An embodiment of the proposed backseat security bag for accommodating lose items inside a vehicle is described herein with reference to FIG. 1 is generally indicated at 10. The apparatus 10 is formed of an outer shell 12 made of a flexible material, such as, by way of non-limiting example, canvas, cloth, plastic or the like having at least one opening, generally indicated at 14 into the interior thereof each with corresponding releasably locking means as shown by the zippers 16. It will be appreciated that other suitable locking means in the art other than zippers may as well be used, such as, by way of non-limiting example, buckles, clasps, hook and loop fasteners or the like provided it maintains the openings to remain closed even during strong impacts in the vehicle. At least one securing strap 18 each having a buckle 20 on the exterior surface of the outer shell 12 are shown for securing the apparatus 10 to the seat belt of the backseat of vehicle. Although seat belts are illustrated in the Figures, it will be appreciated that securing straps 18 and buckles may be selected to connect to other connectors within the back seat of a vehicle, such as, by way of non-limiting example, lower ancors and tethers for children (LATCH) connectors, tie down loops or the like. Multiple openings and multiple buckles are however not limitations. A single opening and a single buckle could also suffice.

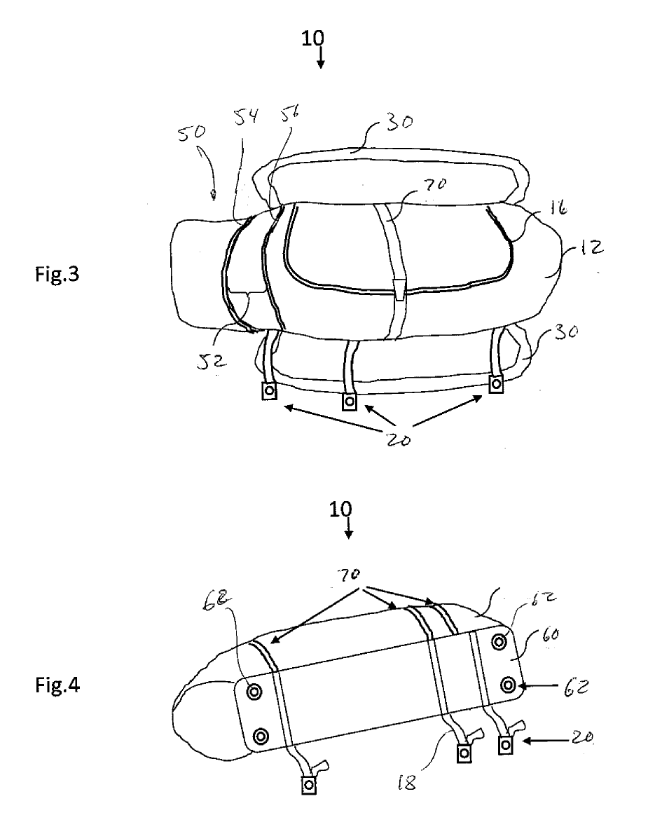

With reference to FIG. 2, a pair of optional user carrying straps 30 for carrying the apparatus 10 on the user's back are shown. The straps 30 are shown to be tied up together by the coupler 32. When the apparatus 10 is inside the vehicle, the straps 30 may also be secured behind the outer shell 12 so that opening and closing the openings is easier as illustrated in FIG. 3. As illustrated in FIG. 3, the outer shell 12 may be is extendable by an extension, generally indicated at 50 to make more space available inside. The extension 50 includes first and second zippered edges, 54 and 56, respectively having a connecting sleeve 52 therebetween which may be separated to increase the size of the apparatus 10 or connected together to render a more compact package. This extension 50 may be zipped back when not required.

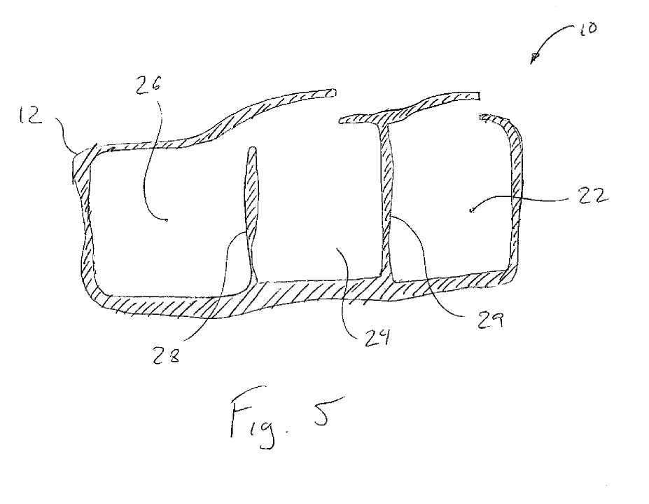

As illustrated in FIG. 4, the outer shell may include a bottom surface 60 which is relatively non-deformable by including a rigid member therein as is commonly known. The bottom surface 60 may also be provided with wheels 62 or casters for wheeling when the bag is outside vehicle.

According to an embodiment, as illustrated in FIG. 3, the apparatus 10 may further include a strap 70 on the exterior of the outer shell for tightening an extra space left after accommodating items inside and zipping up the openings. More of such straps may be provided at locations distributed over the length of the bag 10 as illustrated in FIG. 4.

According to an embodiment, the bag 10 may further comprise a plurality of compartments 22, 24, and 26 separated by one or more dividers, 28 and 29 as illustrated in FIG. 5 within the outer shell 12 for assorted distribution of the items inside to give easier access.

The apparatus 10 may preferably extend over the length of the backseat in a vehicle or at least occupy about two-thirds of the length, though this is not a limitation under the present invention.

The flexible material for the outer shell may be any suitable rugged material available in the art such as a polymer, canvas and the like, as long as the material is suitable for rough usage and has the strength to hold the items inside even under the strong impacts in the vehicle. The flexible shape is useful for accommodating items of various shapes and sizes inside. Besides, with a flexible material, providing extension 50 or zipping up the extension 5 or tightening the extra space with the strap 9 is easier.

In operation, the apparatus may be located within the back seat of a vehicle and the buckles 20 secured to the seatbelt buckles or other connectors of the vehicle. Thereafter a user may locate any desired articles in the apparatus and close the zipper 16 to secure the articles therein.

While specific embodiments of the invention have been described and illustrated, such embodiments should be considered illustrative of the invention only and not as limiting the invention as construed in accordance with the accompanying claims.

What is claimed is:

1. An apparatus for securely accommodating lose items inside a vehicle comprising:
a container of flexible material with an opening;
a releasably locking means for said opening; and
a buckle on the exterior surface of said container for securing the bag to a coupler of the backseat of vehicle.

2. The bag according to claim 1 wherein said locking means is a zipper.

3. The bag according to claim 1 comprising a plurality of said buckles.

4. The bag according to claim 1 comprising a plurality of said openings with corresponding said releasable locking means.

5. The bag according to claim 1 wherein the bottom surface is non-deformable and is provided with wheels for transportation.

6. The bag according to claim 1 further comprising user carrying straps for carrying the bag on the back.

7. The bag according to claim 1 being user extendable to increase the internal volume.

8. The bag according to claim 1 further comprising at least one strap on the exterior of said container for tightening an extra space left within said container after accommodating items.

9. The bag according to claim 1 further comprising a plurality of compartments within said container.

10. The bag according to claim 1 having a length to extend over at least two-thirds of the backseat of vehicle.

11. The bag according to claim 1 wherein said coupler comprises a seat belt.
